(19) United States
(12) Patent Application Publication
(10) Pub. No.: US 2007/0029780 A1
(43) Pub. Date: Feb. 8, 2007

(54) Elastic Bookmark

(76) Inventor: Nancy Harris, Red Oak, TX (US)

Correspondence Address: BROWNING & FLEISHMAN, P.C., P.O. BOX 187, ENNIS, TX, 75120, US

(21) Appl. No.: 11/160,787

(22) Filed: Jul. 8, 2005

(51) Int. Cl. B42D 9/00

(52) U.S. Cl. 281/42

(57) ABSTRACT

Disclosed is an Elastic Bookmark which removably attaches to a book or other reading material and which is used to both temporarily mark a page during a reading session and securely mark the readers place at the end of a reading session. The elastic bookmark is made of one or more pieces of elastic cord fastened together so it has a center section made of elastic cord with a large loop at one end, a small loop at the other and a button at the base of the large loop which can be used to engage the small loop. The device is attached to a book, or other reading material, by placing the cover and, at the readers choice, a convenient number of pages all or part way through the large loop with the button outside the book. The center section is used to temporarily mark the selected page. To securely mark the selected page, the reader stretches the center section, wraps it around the book, and attaches the small loop to the button.

### FIELD OF THE INVENTION

This invention relates generally to a device for marking a reader's place in a book or magazine. More particularly, this invention comprises a device that is removably attached to various sized books or magazines, temporarily marks the reader's place while reading and securely marks the reader's place at the end of a reading session.

### DESCRIPTION OF THE RELATED ART

Bookmarks are typically flat objects laid between the relevant pages and pressed towards the spine of the book. They come in various shapes and sizes, but these typical bookmarks share one thing in common: they fall out, get lost and aggravate the reader.

Several solutions to this problem have been attempted. Some readers, for example, use a rubber band to mark their place. While this bookmark is cheap and does not fall out of the book, it is awkward to mark a new page. Other bookmarks have the advantage of adjustably fastening to the book and separately marking the page, but they are complex and do not securely mark the page when the reader transports the book.

### SUMMARY OF THE INVENTION

It is desirable to have a simple, inexpensive device that fastens to a book or magazine so it will not be lost, marks the current page in a manner that is easy to change, and is capable of securely marking a page for longer periods or while the book or magazine will be transported. Therefore, the object of this invention is a device that will removably fasten to a book or magazine, allow the reader to mark the current page in a manner that is easy to change and more securely mark a page when the book is to be stored or transported.

### DESCRIPTION OF THE DRAWINGS

To further aid in understanding the invention, the attached drawings help illustrate specific features of the invention and the following is a brief description of the attached drawings:

FIG. 1 is an isometric view of the invented device.

FIG. 2 is an isometric view of the invented device being used to mark the current page during a reading session.

FIG. 3 is an isometric view of the invented device being used to securely mark the current page between reading sessions.

### DESCRIPTION OF THE PREFERRED EMBODIMENT OF THE INVENTION

The present invention is a device for marking a reader's place in a book or magazine. This disclosure describes numerous specific details in order to provide a thorough understanding of the present invention. However, the practice of the present invention includes details other than those described. One skilled in the art will appreciate that one may practice the present invention without these specific details. Additionally, this disclosure does not describe some well known structures in detail in order not to obscure the present invention.

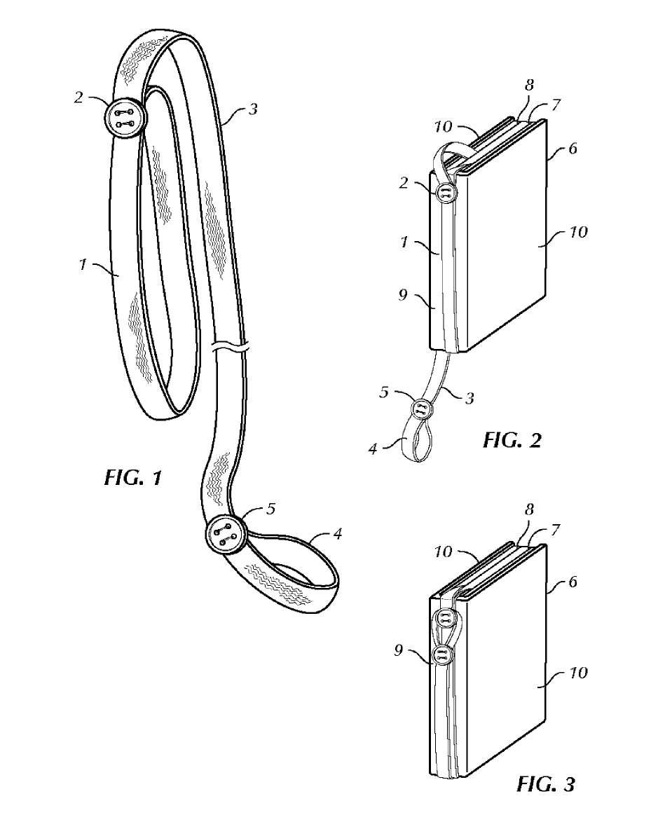

The preferred embodiment of the claimed device and the method of using it is best understood by referring the FIGS. 1 through 3. The device itself can be understood by referring to FIG. 1.

The elastic bookmark is a device made out of a flat, single length of 8 corded, braided elastic which will be referred to herein as a cord. The preferred embodiment uses a cord which is about 3/64″ thick and ¼″ wide.

In the first preferred embodiment, which is designed for a hard cover book, one end of the cord is formed into a large loop 1 by sewing that end of the cord to a point on the length of the cord with a button 2. The length of the cord devoted to the large loop 1 is about 14½″. The button 2 can be of any size and shape, or have any convenient number of fastening holes, but the preferred embodiment uses a button that is round, has four such holes and is about ⅝″ in diameter.

The other end of the cord is formed into a small loop 4 by sewing the other end of the cord to a point of the cord with a second button 5. The length of the cord devoted to the small loop 4 is 2¾″. The second button 5 can be of any size and shape, or have any convenient number of fastening holes, but the preferred embodiment uses a button that is round, has four such holes and is about ½″ in diameter.

Forming the large loop 1 and the small loop 4 as described above leaves a center section 3 that is about 13⅝″ long. The elastic properties of the cord are such that when the large loop 1 is used to fasten the elastic bookmark to a hardcover book of typical size in the manner described below, the reader must use a force of about 1.2 pounds to stretch the large loop 1.

To understand how to removably fix the device to a book and temporarily mark the page, the reader may refer to FIG. 2. The elastic bookmark is fixed to the book when the large loop 1 is used to attach the elastic bookmark to the book 6 by stretching the large loop 1 over a cover 10 and a convenient portion of the pages of the book 6 which are indicated by the attachment page break 7 and sliding the large loop 1 to the binding 9.

Of course, the reader may choose to slide the large loop 1 only part way towards the binding 9 and the convenient number of pages may be zero. The large loop 1 can be rotationally oriented in any manner on the book 6 as long as the button 2 is outside the book 6.

During a reading session, the page is temporarily marked by placing the center section 3 on the selected page 8 with the small loop 9 protruding from the other side of the book 6.

How to best securely mark the page 8 at the end of a reading session is best understood by further referring to FIG. 3. After using the method described above, the center section 3 is stretched and wrapped around the binding 9 and the small loop 4 is slipped over the button 2 in order to prevent the reader's place from being lost if the book is moved. Of course, if the large loop 1 is not pushed all the way to the binding 9, the center section 3 is actually stretched and wrapped around a cover 10 and possibly some of the pages.

A second preferred embodiment for paper back books uses a cord with the same elastic properties as the first embodiment but the amount of cord used to form the large loop 1 is about 11½″, the amount of cord used to form the center section 3 is about 10″ and the other dimensions of the cord, the buttons and the required force are the same as in the first embodiment.

One of ordinary skill in the art can readily see the reasons for the various dimensions chosen in light of the elastic properties. Given the elastic properties of the cord, the size of the large loop 1 is chosen to fit the desired book requiring enough force to not fall off buy little enough force to be convenient to use. The size of the button 2 and small loop 4 are chosen to permit the small loop 4 to be fastened to the button 2. The length of the center section 3 is chosen to permit both the temporary marking of a page as shown in FIG. 2 and the more secure marking shown in FIG. 3 with a convenient amount of force. It is equally obvious that (1) the same objectives can be accomplished with different dimensions if one has a cord with different elastic properties, (2) softer reading materials, such as magazines, may be marked in this manner by using larger dimensions or more elastic materials or both, and (3) smaller or larger reading materials may be so marked by using larger dimensions and/or different elastic properties.

More generally, different sized reading materials of varying degrees of hardness may be accommodated by varying the dimensions and elasticity of the cord. In addition, while the preferred cord is flat, 8 cord, braided elastic, any material that stretches sufficiently may be used. Also, one of ordinary skill in the art will realize that while the preferred embodiment is made of one piece of cord, an elastic book mark may be made from three pieces of cord (one for each of the large loop 1, small loop 4 and center section 3) or two pieces of cord (one for either of the loops 1 or 4 and the center section three and one for the other loop 4 or 1).

The buttons 2 and 5 in the preferred embodiment are used to fasten the ends of the cord to form the loops 1 and 4, but one of ordinary skill in the art will see that the loops 1 and 4 may be formed without one or both of the buttons 2 and 5 and the buttons 2 and/or 5 may be simply fastened to the base of the loops 1 and 4.

The buttons 2 and 5 may be chosen, in shape and decoration, to advertise. For example, a florist may request a flower shaped button for her store to sell or give away. They may also be so chosen for the reader to proclaim some loyalty or affection to something such as a sports team by using the appropriate shape or symbol.

The cord in both of the preferred embodiments is plain and black. However, the cord may be colored, decorated or written upon to advertise or to reflect reader sentiments as described in the preceding paragraph.

Other embodiments of the invention will be apparent to those skilled in the art after considering this specification or practicing the disclosed invention. The specification and examples are exemplary only, with the true scope of the invention being indicated by the following claims:

What is claimed is:

1. An elastic bookmark formed out of a cord comprising: a center section; a large loop at one end of said center section; a button at the base of said large loop; and a small loop at the other end of said center section.

2. The elastic bookmark in claim one wherein said large loop is formed by sewing one end of said cord to a point of said cord with said button.

3. The elastic bookmark in claim one further comprising a second button fixed at the base of said small loop.

4. The elastic bookmark in claim three wherein said large loop is formed by sewing one end of said cord to a point of said cord with said button and said small loop is formed by sewing the other end of said cord to a point of said cord with said second button.

5. A method of temporarily marking the page in a book using the device in claims one, two, three or four comprising: placing all or part of the book cover and none or some of the book's pages within said large loop while leaving said button outside said book; pulling said center section and said small loop through the book at the desired page and closing said book.

6. A method of securely marking the page in a book using the device in claims one, two, three or four comprising: placing all or part of the book cover and none or some of the book's pages within said large loop while leaving said button outside said book; pulling said center section through the book at the desired page; closing said book; and stretching said center section and attaching said second loop to said button.
